(19) United States
(12) Patent Application Publication
(10) Pub. No.: US 2026/0062290 A1
(43) Pub. Date: Mar. 5, 2026

(54) METHODS OF FORMING ACTINIDE-YTTRIUM HYDRIDES AND RELATED COMPOSITIONS AND SYSTEMS

(71) Applicant: Battelle Energy Alliance, LLC, Idaho Falls, ID (US)

(72) Inventors: Jordan A. Evans, Idaho Falls, ID (US); Nicolas E. Woolstenhulme, Idaho Falls, ID (US)

(21) Appl. No.: 19/315,164

(22) Filed: Aug. 29, 2025

Related U.S. Application Data
(60) Provisional application No. 63/690,198, filed on Sep. 3, 2024.

(51) Int. Cl. C01B 6/24

(52) U.S. Cl. CPC C01B 6/24

(57) ABSTRACT

A method of forming an actinide-yttrium hydride includes introducing an yttrium feedstock and an actinide feedstock to a milling/mixing unit. The yttrium and actinide feedstocks are milled and mixed to form a milled mixture. The milled mixture is consolidated in a consolidation unit at a consolidation temperature to form a high-density bulk solid material. The high-density bulk solid material is exposed to hydrogen at a hydriding temperature and a hydriding pressure to form the actinide-yttrium hydride. A composition and system is also disclosed.

### CROSS-REFERENCE TO RELATED APPLICATIONS

This application claims the benefit under 35 U.S.C. § 119 (e) of U.S. Provisional Patent Application Ser. No. 63/690,198, filed Sep. 3, 2024, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The disclosure, in various embodiments, relates to actinide-yttrium hydrides, and to systems and methods of forming the actinide-yttrium hydrides.

### BACKGROUND

Nuclear fuel for use in TRIGAR reactors, which are the most widely used research nuclear reactors in the world, includes uranium-zirconium hydride, or U—ZrHₓ. Zirconium and uranium are miscible with one another and, as a result, U—ZrHₓ nuclear fuel may be formed by a relatively simple process that includes mixing, pressing, sintering, and hydriding. Alternatively, metallic zirconium and uranium may be melted in a furnace, and the molten alloy allowed to cool to form solid uranium-zirconium ingots, which are then hydrided in a hydrogenated atmosphere high-temperature furnace.

U—ZrHₓ nuclear fuel is well suited for use in relatively low temperature operations due to its high fission product retention, strong negative reactivity feedback, excellent chemical stability with a variety of coolants, including water, sodium-potassium alloy (NaK), and sodium (Na), as well as excellent thermophysical stability under large reactivity insertions and frequent power cycling. However, U—ZrHₓ nuclear fuel is prone to excessive hydrogen dissociation and release at higher temperatures and, thus, is not suitable for continuous operation at elevated temperatures (e.g., operating temperatures greater than about 600° C. for commercially-relevant fuel cycle durations). As a result, U—ZrHₓ nuclear fuel is less than ideal for use in a variety of nuclear reactors, such as commercial power generating nuclear reactors, which operate at such elevated temperatures and fuel cycle durations.

U—ZrHₓ nuclear fuel is also well suited for use in small modular reactors and microreactors because the U—ZrHₓ combines the fuel (i.e., uranium) with a neutron-moderating species (i.e., hydrogen), reducing the volume and mass of a core of the reactor. However, the thermal limitations of U—ZrHₓ nuclear fuel (i.e., excessive hydrogen dissociation and release at higher temperatures) will not meet the demands of the next generation of nuclear reactors with small reactor cores (e.g., compact “microreactor” cores) designed to operate at elevated temperatures (e.g., operating temperatures greater than about 600° C.).

### BRIEF SUMMARY

A method of forming an actinide-yttrium hydride includes introducing an yttrium feedstock to a milling/mixing unit and introducing an actinide feedstock to the milling/mixing unit. The method further includes milling and mixing the yttrium feedstock and the actinide feedstock to form a milled mixture, consolidating the milled mixture in a consolidation unit at a consolidation temperature to form a high-density bulk solid material, and exposing the high-density bulk solid material to hydrogen at a hydriding temperature and a hydriding pressure to form the actinide-yttrium hydride.

A composition includes yttrium hydride and one or more actinides. The composition exhibits a bulk nanostructure.

A system for forming an actinide-yttrium hydride material includes a milling/mixing unit configured to reduce an average particle size of an yttrium feedstock and an actinide feedstock to form a milled mixture, a consolidation unit coupled to the milling/mixing unit and configured to consolidate the milled mixture of the yttrium feedstock and the actinide feedstock into a high-density solid material, and a hydriding unit coupled to the consolidation unit and configured to hydride the high-density solid material.

### BRIEF DESCRIPTION OF THE DRAWINGS

FIG. 1 is a simplified diagrammatic view of a system for producing actinide-yttrium hydrides, in accordance with embodiments of the disclosure; and

FIG. 2 is a simplified block diagram of a method of producing actinide-yttrium hydrides, in accordance with embodiments of the disclosure.

### DETAILED DESCRIPTION

The following description provides specific details, such as material compositions and processing conditions (e.g., temperatures, pressures, etc.), in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the disclosure are described in detail below. A person of ordinary skill in the art will understand that some process components (e.g., pipelines, line filters, valves, temperature detectors, flow detectors, pressure detectors, and the like) are inherently disclosed herein and that adding various conventional process components and acts would be in accord with the disclosure. In addition, the drawings accompanying the application are for illustrative purposes only and are not meant to be actual views of any particular material, device, or system.

As used herein, the singular forms “a,” “an,” and “the” are intended to include the plural forms as well, unless the context clearly indicates otherwise.

As used herein, the term “configured” refers to a size, shape, material composition, material distribution, orientation, and arrangement of one or more of at least one structure and at least one apparatus facilitating operation of one or more of the structure and the apparatus in a pre-determined way.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “bulk nanostructure” refers to a microstructure present throughout a volume of a consolidated body (i.e., not limited to a surface layer or thin film) in which characteristic feature sizes are at the nanometer scale. A bulk nanostructure may include a nanoscale dispersion composite in which a continuous primary matrix of yttrium or yttrium hydride exhibits equiaxed grains having nanoscale dimensions, and a secondary actinide phase forms nanoscale inclusions. The inclusions may be distributed along grain boundaries of the matrix and may act as grain-boundary pinning sites. The consolidated body may exhibit a low degree of crystallographic texture and low defect density.

As used herein, the term “high-density bulk solid material” refers to a consolidated body including yttrium and one or more actinides that exhibits a density greater than about 90% of the maximum theoretical density, and that may include less than about 1% porosity. The high-density bulk solid material may be produced by consolidation under elevated temperature and pressure (e.g., high-temperature equal-channel angular extrusion or hot isostatic pressing). The high-density bulk solid material may have a bulk nanostructure present throughout the volume of the consolidated body.

Actinide-yttrium hydrides (e.g., uranium-yttrium hydride (U—YHₓ), plutonium-yttrium hydride (Pu—YHₓ), and uranium-plutonium-yttrium hydride (U—Pu—YHₓ)) may be used as metal-hydride nuclear fuels because of the ability of yttrium to retain hydrogen at higher temperatures and for longer durations of time than uranium-zirconium hydride, or U—ZrHₓ, nuclear fuel. Unlike zirconium, uranium, and plutonium, which are readily miscible, yttrium is immiscible with both uranium and plutonium. Therefore, conventional processes of forming actinide-zirconium hydrides (An—ZrHₓ) are not suitable for forming actinide-yttrium hydrides (An—YHₓ). Commercially insignificant amounts of An—YHₓ have been produced using power-metallurgical procedures (e.g., hot pressing), but structural integrity of the resulting An—YHₓ was found to severely degrade at higher temperatures and under irradiation, ultimately resulting in the An—YHₓ prematurely crumbling. Without being bound to any theory, it is believed that previous attempts at fabricating An—YHₓ failed because the microstructure underwent rapid changes at high temperatures and under irradiation, leading to loss of mechanical integrity and premature crumbling of the fuel.

Producing commercially viable quantities of stable An—YHₓ, such as for use as a nuclear fuel, may depend on the ability to manufacture a dispersion microstructure that remains stable at higher operating temperatures and burnup conditions. The An—YHₓ according to embodiments of the disclosure exhibits higher temperature hydrogen stability compared to An—ZrHₓ and, therefore, may be used safely at much higher temperatures and under irradiation conditions while retaining its hydrogen content better than An—ZrHₓ at the same temperature and irradiation conditions. The An—YHₓ may achieve a desired neutron energy spectrum in a reactor without including large volumes of additional materials in the reactor (blocks of graphite, pools of water, etc.). The production of a stable An—YHₓ was unexpected due to the immiscibility of yttrium with both uranium and plutonium. The production of An—YHₓ would be a large advancement in metal-hydride nuclear fuels and moderators. The An—YHₓ according to embodiments of the disclosure may be formed by combining (e.g., mixing) feedstocks of yttrium with one or more actinides (e.g., uranium, plutonium, combinations thereof), mechanically alloying the actinide and yttrium, consolidating the actinide and yttrium into metallic composite pellets, and hydriding the consolidated actinide and yttrium. Optionally, an additive feedstock may be included with the feedstocks of actinide and yttrium. The additive feedstock may include a burnable neutron absorber, such as a rare earth metal.

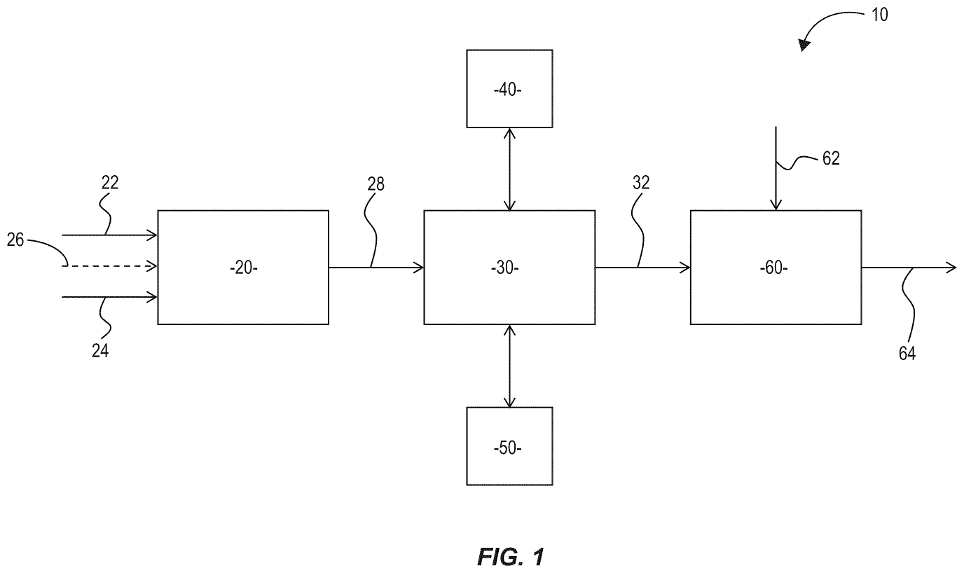

FIG. 1 presents a simplified diagrammatic view of a system 10 for forming an actinide-yttrium hydride, in accordance with embodiments of the disclosure. The system 10 includes a milling/mixing unit 20. The milling/mixing unit 20 is configured to reduce the size of feedstock materials (e.g., solid feedstock materials) processed therein. In addition, the milling/mixing unit 20 combines (e.g., mixes) the feedstock materials that have been reduced in size into a milled mixture having a substantially homogeneous distribution of the different feedstock materials throughout.

In accordance with some embodiments of the disclosure, the milling/mixing unit 20 is configured to perform high-energy ball milling. In other embodiments, the milling/mixing unit 20 is configured to perform jet milling, as discussed in further detail below. More particularly, in some embodiments, the milling/mixing unit 20 includes a milling/mixing vessel into which one or more feedstock materials (e.g., solid feedstock materials) are introduced (e.g., added). The feedstock materials are rapidly and repeatedly contacted at high-velocity and, thus, high-energy, by milling balls disposed in the milling/mixing vessel with the feedstock materials. The milling/mixing vessel may be rotated at high-speed (e.g., about 2,000 revolutions per minute), which may cause the milling balls to rapidly rise and fall into repeated contact with the feedstock materials. In some embodiments, the milling/mixing vessel is translated at high speed (e.g., horizontally translated at about 2,000 cycles per minute, vertically translated at about 2,000 cycles per minute), which may cause the milling balls to rapidly and repeatedly contact the feedstock materials. The rapid and repeated contact of the feedstock materials with the milling balls at high velocity and high energy reduces the average particle size of the feedstock materials. By way of example only, the particle size of the feedstock materials may be significantly reduced, such as by one or more orders of magnitude, following the milling.

The milling balls may be formed of a material having a hardness that is greater than a hardness of the feedstock materials being contacted. The metals of the feedstock materials may be malleable in powder form. The feedstock materials may be mixed and milled in the milling/mixing unit 20 at a temperature greater than or equal to about 0° C. depending on the ductility of the metals in the feedstock materials. For instance, the feedstock materials may be mixed and milled at a temperature of from about 0° C. to about 30° C., such as from about 20° C. to about 25° C. If the metals are too ductile at these temperatures, the feedstock materials may be mixed and milled at a sub-zero temperature. In accordance with some embodiments of the disclosure, the milling/mixing unit 20 is configured to perform cryomilling. In these embodiments the milling/mixing unit 20 performs high-energy ball milling under cryogenic conditions (e.g., temperatures ranging from about −196° C. to about 0° C.).

In some embodiments, the milling/mixing unit 20 is configured to perform jet milling, in which the feedstock materials are propelled through one or more converging-diverging nozzles using pressurized air or a high-purity, pressurized inert gas (e.g., argon). As the gas expands, the feedstock materials accelerate to supersonic velocity and collide with one another within a grinding chamber, fracturing along crystal defects and reducing their average particle size. Because size reduction occurs by particle-to-particle impact, no grinding media are introduced and contamination of the feedstock materials is substantially minimized. The grinding chamber may include an internal classifier that continuously removes (e.g., extracts) particles having an average particle size below a predetermined cut-off (e.g., below about 100 nm to about 5 μm), allowing larger sized particles to remain for further size reduction until a desired particle-size distribution is achieved. In some embodiments, the jet milling proceeds under cryogenic conditions (e.g., temperatures ranging from about −196° C. to about 0° C.), which decreases the ductility of the metals and promotes brittle fracture of the powders.

The initial feedstock materials (e.g., solid feedstock materials) may be powders having average particle sizes of from about 5 micrometers (μm) to about 500 μm, such as from about 10 μm to about 100 μm, or from about 50 μm to about 300 μm. After conducting the milling and mixing, the feedstock materials may be reduced to average particle sizes of less than about 300 μm, such as less than about 50 μm. By way of example only, the feedstock materials may be reduced to an average particle size of from about 300 nanometers (nm) to about 100 micrometers (μm), such as from about 300 nm to about 500 nm, from about 500 nm to about 1 μm, or from about 1 μm to about 100 μm. A desired post-milling average particle size may depend on a technique used for consolidation. If, for example, high-temperature equal channel angular extrusion (ECAE) is used, the post-milling average particle size may be from about 1 μm to about 100 μm. Alternatively, if hot isostatic pressing (HIP) is used, the post-milling average particle size may be as small as possibly achieved by the mixing and milling, such as less than about 50 μm. This significant reduction in average particle size (i.e., order(s) of magnitude reduction in average particle size) of disparate feedstock materials facilitates homogeneous distribution (e.g., substantially homogeneous distribution) of the feedstock materials in the milled mixture within the milling/mixing unit 20. The milling/mixing unit 20 may be configured to perform high-energy ball milling on a batch, semi-batch, or continuous basis.

With continued reference to FIG. 1, one or more feedstock inputs may be introduced to the milling/mixing unit 20, such as an yttrium feedstock input 22, an actinide feedstock input 24, and, optionally, an additive feedstock input 26. The yttrium feedstock may be substantially pure yttrium, such as about 99 weight-percent (wt %) pure, about 99.5 wt % pure, about 99.9 wt % pure, or about 99.99 wt % pure. The yttrium feedstock may be a solid in powder form initially having an average particle size of from about 5 μm to about 500 μm, such as from about 10 μm to about 100 μm, or from about 50 μm to about 300 μm. After the milling and mixing, the yttrium feedstock may be reduced to an average particle size of less than about 300 μm, such as less than about 50 μm. The average particle size of the yttrium feedstock may be within the ranges described above for the actinide feedstock. The yttrium feedstock, both before and after the milling and mixing, is formed of and includes a powder having particles with large surface area-to-volume ratios, which are subject to oxidation (i.e., each particle is small in volume). As such, processes involving the storage, transfer, and milling/mixing of the solid feedstocks, as well as subsequent handling and processing of the milled mixtures formed therefrom, may be conducted in an oxygen-depleted environment (e.g., under a high purity, inert atmosphere, or under vacuum) to minimize (e.g., substantially minimize, prevent) oxidation of the solid feedstocks and/or milled mixtures formed therefrom. The inert atmosphere may include, for example, one or more of high purity argon, high purity helium, and high purity neon.

The yttrium feedstock input 22 is configured to transfer a preselected amount of the yttrium feedstock into the milling/mixing unit 20. The preselected amount of the yttrium feedstock transferred into the milling/mixing unit 20 may account for from about 5 wt % to about 95 wt % of the total amount of milled mixture formed, such as from about 20 wt % to about 80 wt %, from about 30 wt % to about 70 wt %, from about 85 wt % to about 90 wt %, or from about 45 wt % to about 55 wt %. In accordance with some embodiments of the disclosure, the preselected amount of the yttrium feedstock transferred into the milling/mixing unit 20 accounts for from about 55 wt % to about 70 wt % of the total amount of milled mixture formed. In some embodiments, the yttrium may account for greater than about 50 wt % but less than about 100 wt % of the resulting actinide-yttrium hydride.

As shown in FIG. 1, the actinide feedstock may be introduced into the milling/mixing unit 20 through an actinide feedstock input 24. The actinide feedstock may be substantially pure, such as about 99 wt % pure, about 99.5 wt % pure, about 99.9 wt % pure, or about 99.99 wt % pure. The actinide feedstock may include fissile uranium isotopes (e.g., uranium-235), non-fissile uranium isotopes (e.g., uranium-238, uranium-234), fissile plutonium isotopes (e.g., plutonium-239), non-fissile plutonium isotopes (e.g., plutonium-240, plutonium-242), or any combination of uranium and plutonium isotopes. In addition, the actinide feedstock may be a solid in powder form having an average particle size of from about 5 μm to about 500 μm, such as from about 10 μm to about 100 μm, or from about 50 μm to about 300 μm. After conducting the milling and mixing process, the actinide feedstock may be reduced to an average particle size of less than about 300 μm as previously described. The actinide feedstock input 24 is configured to transfer a pre-selected amount of the actinide feedstock into the milling/mixing unit 20. In embodiments where the actinide feedstock includes both plutonium and uranium, the plutonium and uranium may be introduced into the milling/mixing unit 20 together (e.g., concurrently), while in other embodiments the plutonium and uranium may be introduced into the milling/mixing unit 20 separately (e.g., sequentially). The pre-selected amount of the actinide feedstock transferred into the milling/mixing unit 20 may account for from about 5 wt % to about 95 wt % of the total amount of milled mixture formed, such as from about 20 wt % to about 80 wt %, from about 30 wt % to about 70 wt %, or from about 45 wt % to about 55 wt %. In accordance with some embodiments of the disclosure, the pre-selected amount of the actinide feedstock transferred to the milling/mixing unit 20 is from about 30 wt % to about 45 wt % of the total amount of milled mixture formed, although higher and lower amounts may be used. In some embodiments, the actinide component (i.e., one or more of uranium and plutonium) may account for up to about 50 wt % of the resulting actinide-yttrium hydride.

In accordance with some embodiments of the disclosure, an additive feedstock may optionally be introduced to the milling/mixing unit 20 through an additive feedstock input 26, as indicated by the dashed line in FIG. 1. The additive feedstock input 26 transfers a preselected amount of an additive feedstock to the milling/mixing unit 20. The additive feedstock may be a solid in powder form and, similar to the yttrium feedstock and the actinide feedstock, the additive feedstock may have an initial average particle size of from about 5 μm to about 500 μm, such as from about 10 μm to about 100 μm, or from about 50 μm to about 300 μm. After conducting the milling and mixing process, the additive feedstock may be reduced to an average particle size of less than about 300 μm, such as less than about 50 μm. The average particle size of the additive feedstock may be within the ranges described above for the actinide and yttrium feedstocks. The amount of additive feedstock transferred to the milling/mixing unit 20 may depend on the specific reactor design that the fuel is eventually used in, as reactors with large power peaking may benefit from slightly higher burnable absorber content.

The additive feedstock in accordance with embodiments of the disclosure may include a burnable neutron absorber (e.g., a burnable absorber) to improve the neutronics, handling safety, and operation of a nuclear reactor in which the An—YHₓ according to embodiments of the disclosure is used. Including the burnable absorber may not influence fabrication procedures or thermophysical properties of the resulting An—YHₓ. The burnable absorber may extend the operational lifetime of a nuclear fuel, which improves the economics of operating a reactor utilizing a nuclear fuel having one or more burnable absorbers added thereto. The burnable absorber may be a rare earth metal. In some embodiments, the burnable absorber is boron (B), gadolinium (Gd), erbium (Er), europium (Eu), samarium (Sm), dysprosium (Dy), hafnium (Hf), cadmium (Cd), indium (In), lutetium (Lu), iridium (Ir), or a combination thereof. The burnable absorber may account for less than about 10 wt % of the total amount of the milled mixture formed, such as from about 0.1 wt % to about 10 wt %, from about 0.1 wt % to about 2 wt %, from about 0.1 wt % to about 1 wt %, from about from about 0.5 wt % to about 5 wt %, from about 0.5 wt % to about 3 wt %, or 0.5 wt % to about 1 wt %, from about 5 wt % to about 10 wt %, and from about 7 wt % to about 10 wt %.

With reference again to FIG. 1, a milled mixture output 28 is configured to transfer the milled mixture formed in the milling/mixing unit 20 to a consolidation unit 30 for further processing. The milled mixture is transferred from the milling/mixing unit 20 to the consolidation unit 30 through the milled mixture output 28. The milling/mixing unit 20 combines the feedstock materials (e.g., different solid feedstock materials) and reduces them in size to form the milled mixture having a substantially homogeneous distribution of the different materials (e.g., yttrium powder, actinide powder, uranium powder, plutonium powder) throughout. The milled mixture may include particles of two or more metals from the solid feedstock materials. In some embodiments, a milled mixture includes microparticles of yttrium and microparticles of actinide substantially homogeneously distributed throughout. Although the milled mixture may appear substantially homogeneous to the naked eye, the milled mixture includes yttrium microparticles with actinide microparticles distributed throughout.

In embodiments of the disclosure in which an additive feedstock is introduced into the milling/mixing unit 20 along with the yttrium feedstock and actinide feedstock, the milled mixture may include microparticles of yttrium, microparticles of the actinide, and microparticles of the additive feedstock substantially homogeneously distributed throughout. As before, the additive feedstock may include a burnable absorber, for example, one or more of boron (B), gadolinium (Gd), erbium (Er), europium (Eu), samarium (Sm), dysprosium (Dy), hafnium (Hf), cadmium (Cd), indium (In), lutetium (Lu), iridium (Ir).

As with the handling and processing of the feedstock materials associated with the milling/mixing unit 20, the transfer of the milled mixture from the milling/mixing unit 20 to the consolidation unit 30 may be conducted in an oxygen-depleted or inert atmosphere to minimize (e.g., substantially minimize) oxidation of the components of the milled mixture.

The consolidation unit 30 consolidates the milled mixture into a high-density bulk solid material output 32 that exhibits, for example, greater than about 90% of the maximum theoretical density. The high-density bulk solid material may exhibit greater than about 95% of the maximum theoretical density or greater than about 99% of the maximum theoretical density. The high-density bulk solid material may, for example, include less than about 1% porosity. The consolidation act may incorporate both high temperature and high pressure conditions simultaneously to densify the milled mixture into the high-density bulk solid material. The resulting high-density bulk solid material may include the burnable absorber at between 0% by weight and about 10% by weight.

In accordance with some embodiments of the disclosure, the consolidation unit 30 is configured to perform high-temperature equal channel angular extrusion (ECAE). High-temperature ECAE exposes different solid materials simultaneously to elevated temperatures and elevated pressures to form the high-density bulk solid material. High-temperature ECAE consolidates different solid materials by forcing the various solid materials (e.g., metal powders, milled mixture), which have been heated to an elevated consolidation temperature (e.g., at temperatures up to about 1150° C.), through a 90-degree elbow in a channel, where the channel and the 90-degree elbow in the channel have substantially equal cross-sectional dimensions (e.g., substantially equal widths, substantially equal heights, substantially equal diameters). However, the elbow in the channel may range from about a 60-degree elbow to about a 120-degree elbow. Forcing the milled mixture through the elbow in the channel causes an elevated consolidation pressure in the consolidation unit 30. The high temperature softens the solid materials, enabling the solid materials to be more easily forced through the channel while recovering defects and minimizing porosity. The temperature may be adjusted if the resulting microstructure of the high-density bulk solid material is too coarse or if the porosity is too high. The resulting high-density bulk solid material may exhibit a bulk nanostructure while including low amounts of defects and low degree of texture.

With reference again to FIG. 1, a temperature control unit 40 is disposed in communication with the consolidation unit 30. The temperature control unit 40 is configured to adjust and maintain a temperature (e.g., a consolidation temperature) in the consolidation unit 30 throughout a consolidation process performed therein. The consolidation temperature may be from about 20° C. to about 1150° C., such as from about 20° C. to about 250° C., from about 250° C. to about 450° C., from about 450° C. to about 700° C., from about 700° C. to about 900° C., or from about 900° C. to about 1150° C., (e.g., about 700° C.).

With continued reference to FIG. 1, a pressure control unit 50 is also disposed in communication with the consolidation unit 30. The pressure control unit 50 is configured to adjust and maintain a pressure (e.g., a consolidation pressure) in the consolidation unit 30 throughout a consolidation process performed therein.

The milled mixture may be extruded multiple times via high-temperature ECAE, with the extruded material being rotated about an axis extending longitudinally through the extruded material between successive passes through the elbow (e.g., the 90-degree elbow) in the channel having the substantially equal cross-sectional dimensions (e.g., substantially equal widths, substantially equal heights, substantially equal diameters). In accordance with some embodiments of the disclosure, high-temperature ECAE is performed in a channel having several 90-degree elbows which all have substantially equal cross-sectional dimensions, wherein each of the 90-degree elbows is disposed in a different direction relative to a preceding 90-degree elbow such that the axis extending longitudinally through the material being extruded is effectively rotated prior to being extruded through subsequent ones of the 90-degree elbows.

The result of the high-temperature ECAE in accordance with embodiments of the disclosure is that the different solid materials (e.g., metal powders, milled mixture) are subjected to repeated severe plastic deformation resulting in bulk grain refinement, while defects are recovered as a result of the exposure of the different solid materials to the elevated temperatures and pressures, simultaneously. The strain on the different solid materials resulting from the simultaneous exposure to the elevated consolidation temperature and elevated consolidation pressure while being forced through the channel with the one or more elbows induces mixing and alloying of different elemental species of the solid materials, forming the high-density bulk solid material. The angle of the one or more elbows may be from about 60-degrees to about 120-degrees. In addition, the high strain on metallic powders (e.g., yttrium powders, actinide powders, additive powders) breaks and smears oxide surfaces, which expose new surfaces for the elemental species of the powders to bond together. Unlike other forms of extrusion, the pure shear deformation of high-temperature ECAE combined with rotating the extruded material about a longitudinal axis extending therethrough between multiple ECAE passes can substantially reduce (e.g., remove) texture of the extruded material. In hexagonal close-packed metals that exhibit strong initial textures, such as yttrium, the texture intensity often decreases after high-temperature ECAE. The nanostructure of the high-density bulk solid material formed by high-temperature ECAE may include nanoparticles of the actinide phase embedded within the immiscible nanocrystalline yttrium phase. The nanocrystalline yttrium may be in the delta phase, with nanoparticles of the actinide within the yttrium matrix.

The nanostructure of the high-density bulk An—YHₓ may be characterized as a nanoscale dispersion composite (i.e., a two-phase material in which nanosized particles or precipitates of a secondary phase are distributed throughout a continuous primary matrix). After consolidation, the primary yttrium phase may exhibit equiaxed grains having an average diameter within a range of from about 70 nm to about 150 nm, such as from about 70 nm to about 100 nm, from about 100 nm to about 120 nm, from about 120 nm to about 140 nm, or from about 140 nm to about 150 nm. The actinide secondary phase, which includes one or more of uranium and plutonium, remains immiscible with yttrium and forms nearly spherical inclusions that preferentially segregate to the grain boundaries of the yttrium matrix. The actinide inclusion diameters may be within a range of from about 10 nm to about 60 nm, such as from about 10 nm to about 25 nm, from about 25 nm to about 40 nm, from about 40 nm to about 50 nm, or from about 50 nm to about 60 nm. Finely dispersed actinide inclusions may be distributed along grain boundaries of the yttrium matrix, forming a stable two-phase nanostructure in which nanoscale actinide particles are embedded within larger equiaxed yttrium grains. The finely dispersed actinide inclusions may act as effective grain-boundary pinning sites in the An—YHₓ, inhibiting coarsening and preserving the nanostructure during elevated-temperature service and irradiation.

In accordance with some embodiments of the disclosure, consolidation of the milled mixture in the consolidation unit 30 configured to perform high-temperature ECAE includes heating the milled mixture to a temperature of about 700° C., and simultaneously applying a pressing rate of up to about 50 millimeters per second (mm·s⁻¹) to force the heated milled mixture through the 90-degree elbow in the channel having the substantially equal cross-sectional dimensions for a total of four passes, with Be rotation (i.e., clockwise rotation of 90° about the longitudinal axis) of the extruded material performed after each pass. However, the temperature may range from about 20° C. to about 1150° C. and the pressing rate may range from about 1 mm·s⁻¹ to about 50 mm s⁻¹, such as from about 1 mm s⁻¹ to about 10 mm·s⁻¹, from about 10 mm·s⁻¹ to about 25 mm·s⁻¹, or from about 25 mm s⁻¹ to about 50 mm·s⁻¹. Other rotation schemes (e.g., routes), such as Route A, Route Bₐ, or Route C may be used. Route A involves no rotation of the milled mixture between successive equal-channel angular extrusion passes, so shear is applied on two planes that meet at 90° and the milled mixture elongates progressively without any periodic restoration of its original geometry. Route C uses a 180° rotation after every pass; because each pass shears on the same plane, the milled mixture regains its initial orientation after every two passes and the cumulative distortion is partially self-cancelling. Route Bₐ is a variant in which the milled mixture is rotated by 90° between passes but the direction of rotation alternates; this sequence imposes shear on a family of planes that intersect at roughly 120°, so the milled mixture continues to distort in a manner similar to Route A without returning to its starting orientation. The implementation of four passes of the extruded material with B_{c} rotation performed after each pass ensures that the lattice rotation-induced texture is offset by restoring the symmetry of the volume element every 4 (n) passes, where n is an integer. After an initial four passes, a total strain of about 450% yields the high-density bulk solid material including an equiaxed yttrium matrix grain size on the order of about 100 nm with actinide inclusions tens of nanometers (e.g., from about 10 nm to about 50 nm) in diameter located at the grain boundaries of the yttrium matrix. If, however, the microstructure in the high-density bulk solid material remains too coarse, the high-density bulk solid material may be subjected to additional cycles of four passes through the high-temperature ECAE unit, with B_{c} rotation performed after each pass. In some embodiments, the high-density bulk solid material formed in the consolidation unit 30 has a porosity of less than 1 percent.

The consolidation unit 30 in accordance with other embodiments of the disclosure may be configured to perform hot isostatic pressing (HIP) in which the different solid materials (e.g., milled mixture) are subjected to elevated pressure (i.e., isostatic gas pressure) while simultaneously elevating the temperature to which the different solid materials are exposed. More particularly, the different solid materials are placed in a thin-walled container which is positioned in a gas chamber within a high-pressure containment vessel. The gas chamber is pressurized with gas, such as an inert gas (e.g., argon gas), so that the gas pressure is homogeneously distributed (i.e., isostatic pressure) around the thin-walled container, and thus, around the solid materials contained inside. The gas chamber in the high-pressure containment vessel may be heated, causing the pressure inside the gas chamber to increase, thus increasing the isostatic pressure surrounding the thin-walled container and, once again, surrounding the solid material contained inside.

In accordance with embodiments of the disclosure, the consolidation unit 30 configured to perform HIP is employed to consolidate the solid materials (e.g., milled mixture) by simultaneously applying an elevated isostatic consolidation pressure of from about 50 MPa to about 10,000 MPa (e.g., about 5,000 MPa) at an elevated consolidation temperature of from about 500° C. to about 1300° C. (e.g., about 1200° C.) for about 1 minute to about 24 hours, such as from about 1 minute to 1 hour, from about 1 hour to about 5 hours, from about 5 hours to about 15 hours, and from about 15 hours to about 24 hours.

In some embodiments the milled mixture is first consolidated into a dense intermediate structure before entering the consolidation unit 30 for high-temperature ECAE or HIP. For example, the milled mixture may be consolidated into a dense intermediate structure by HIP as described above; standard pressureless sintering under vacuum or an inert atmosphere conducted within comparable temperature ranges; or electric-field-assisted sintering (e.g., spark-plasma sintering) at a temperature within a range of from about 600° C. to about 900° C. while applying a uniaxial pressure within a range of from about 20 MPa to about 50 MPa. These operations fuse adjacent particulates to produce the dense intermediate structure, which may then be consolidated using ECAE in the consolidation unit 30.

In some embodiments, the milled mixture may instead be shaped into a dense intermediate structure having a desired geometry using additive-manufacturing techniques such as powder-bed fusion, directed-energy deposition, or binder jetting. The dense intermediate structure may then be consolidated in the consolidation unit 30 using HIP under the conditions noted above to achieve at least about 99 percent of the maximum theoretical density.

After formation in the consolidation unit 30, the high-density bulk solid material formed from the solid materials (e.g., milled materials) is transferred from the consolidation unit 30 to a hydriding unit 60, as shown in FIG. 1. The hydriding unit 60 is configured to contact the high-density bulk solid materials (e.g., high-density bulk solid actinide-yttrium materials, high-density bulk solid actinide-yttrium-additive materials) with hydrogen gas, supplied via a hydrogen gas input 62, while maintaining a hydriding temperature and a hydriding pressure within the hydriding unit 60. The hydriding temperature may range from about 500° C. to about 900° C., such as about 700° C. At a lower temperature within this range, hydriding the high-density bulk solid material may take longer while at a higher temperature within this range, hydriding the high-density bulk solid material may result in a heterogeneous (e.g., a gradient of hydrogen) composition. The hydriding pressure may depend on the hydrogen gas partial pressure used. The hydrogen gas may be supplied as 100% hydrogen gas or as a gas mixture including the hydrogen gas and an inert gas (e.g., argon). For example, a gas mixture of 5 vol % hydrogen and 95 vol % argon or 1 vol % hydrogen and 99 vol % argon may be used. The temperature and hydrogen gas partial pressure may be tailored to achieve a desired amount of hydrogen in the high-density bulk solid material.

Maintaining the high-density bulk solid material in the hydriding unit 60 in the presence of hydrogen gas results in diffusion of at least some of the hydrogen into the high-density bulk solid material. By way of example only, the high-density bulk solid material may have a chemical formula of An—YHₓ, where x is H/Y (i.e., the atomic ratio of hydrogen atoms to yttrium atoms present). The value of x may range from about 0.4 to about 3, and x may be an integer or a non-integer. In accordance with some embodiments of the disclosure, x is equal to about 1.9, and the chemical formula of the high-density bulk solid material is represented as An—YH_{1.9} (i.e., 1.9 hydrogen atoms are present for one yttrium atom in the high-density bulk solid material after the hydriding process). However, other values of x that yield a δ (i.e., delta) phase Y—Hₓ may be used. The hydrogen atoms, which diffuse into the high-density bulk solid material in the hydriding unit 60, almost exclusively bond with the yttrium atoms because hydrogen-uranium and hydrogen-plutonium bonds are not stable at temperatures above about 600° C., which is less than the hydriding temperature (e.g., about 700° C.). Without being bound by any theory, the hydrogen is believed to provide increased hydrogen stability to the An—YHₓ, which enables the An—YHₓ to be safely used as a nuclear fuel at much higher temperatures than conventional TRIGA fuel. The hydrogen is also extremely effective at slowing down (i.e., moderating) fast neutrons. The An—YHₓ is believed to be stable under extreme conditions due to the abundance of particle pinning effects and high defect sink densities resulting from the nano-scale crystallographic features produced by the manufacturing process described above.

Although a wide range of hydrogen content (i.e., values of x) may be attained in the hydriding unit 60, the H/Y atomic ratio of about 1.9/1 was selected because it results in a sufficient amount of hydrogen being present to be neutronically significant. In addition, YH_{1.9} crystallizes in the cubic δ phase at reactor-relevant fuel temperatures, which at least partially mitigates anisotropic dimensional changes during use while avoiding an undesirable volume expansion of the α-to-δ phase transition that may occur as temperature rises in YHₓ compounds having lower hydrogen content. The hydriding parameters (i.e., hydriding temperature, hydriding pressure) are defined by temperature-pressure isochores (i.e., curves on a pressure-temperature diagram along which the hydrogen content remains constant) for the selected YHₓ stoichiometry, and may be adjusted along the appropriate isochore to attain the desired hydrogen content while forming a δ-YHₓ phase. For example, a combination of about 700° C. and a hydrogen partial pressure of about 0.122 Torr lies on the x=1.90 isochore, but other pressure and temperature combinations may yield x=1.90. Lower hydrogen partial pressures at the same temperature that satisfy the x=1.50 isochore may likewise be employed when a lower hydrogen content is desired while still forming a δ-phase. Because the high-density bulk solid material may crack if the hydriding temperature, hydrogen partial pressure, or resulting composition gradients are too large, in some embodiments, the hydriding unit 60 is operated at temperatures within a range of from about 500° C. to about 850° C., such as from about 500° C. to about 650° C., from about 650° C. to about 750° C., or from about 750° C. to about 850° C., while the hydrogen partial pressure is adjusted to remain on the selected isochore. Upon completion of the hydriding process, the actinide-yttrium hydride (e.g., U—YH_{1.9}) is discharged from the hydriding unit 60 via the actinide-yttrium hydride outlet 64, as shown in FIG. 1. The actinide-yttrium hydride may be recovered from the hydriding unit 60.

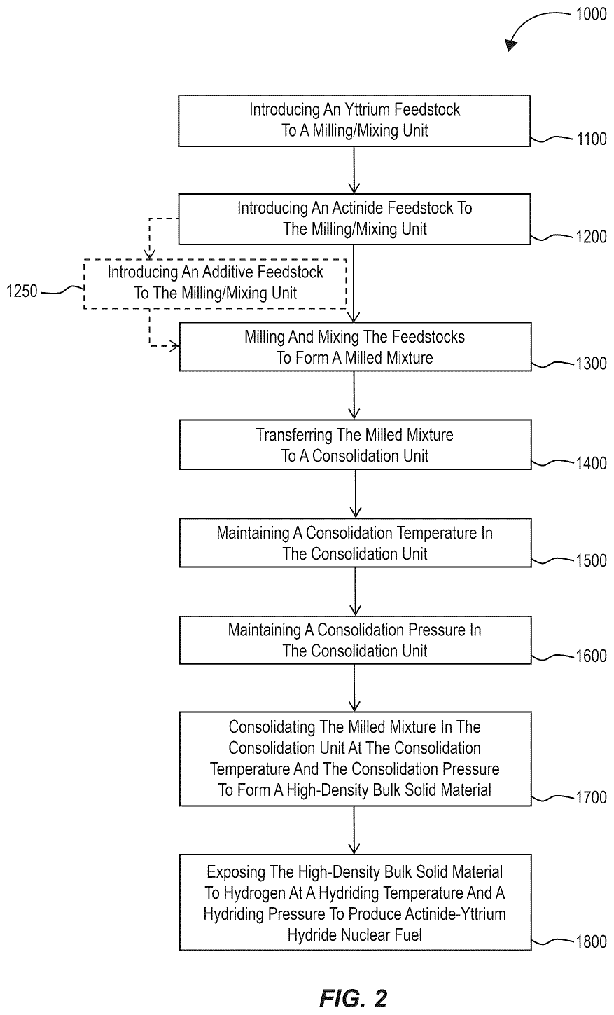

FIG. 2 presents a simplified block diagram of a method of forming an actinide-yttrium hydride, in accordance with embodiments of the disclosure. The method 1000 of forming an actinide-yttrium hydride includes an act 1100 of introducing (e.g., adding) an yttrium feedstock (e.g., a solid yttrium feedstock) to a milling/mixing unit (e.g., milling/mixing unit 20). The yttrium feedstock may be substantially pure, such as about 99 wt % pure, about 99.5 wt % pure, about 99.9 wt % pure, or about 99.99 wt % pure. In addition, the yttrium feedstock may be a solid in powder form having an average particle size of from about 5 μm to about 500 μm, such as from about 10 μm to about 100 μm, or from about 50 μm to about 300 μm. The amount of the yttrium feedstock added to the milling/mixing unit may account for from about 5 wt % to about 95 wt % of the total amount of milled mixture formed, such as from about 20 wt % to about 80 wt %, from about 30 wt % to about 70 wt %, from about 45 wt % to about 55 wt %, or from about 55 wt % to about 70 wt % of the total amount of milled mixture formed. In accordance with embodiments of the disclosure, the act 1100 of adding the yttrium feedstock to the milling/mixing unit, as well as subsequent acts of the method 1000, may be carried out in an oxygen-depleted environment (e.g., under a vacuum, under an inert gas blanket).

The method 1000 also includes an act 1200 of introducing (e.g., adding) an actinide feedstock (e.g., a solid actinide feedstock) to the milling/mixing unit. Similar to the yttrium feedstock, the actinide feedstock may be substantially pure, such as about 99 wt % pure, about 99.5 wt % pure, about 99.9 wt % pure, or about 99.99 wt % pure. As described above with regard to the system 10, the actinide feedstock may include fissile uranium isotopes (e.g., uranium-235), non-fissile uranium isotopes (e.g., uranium-238, uranium-234), fissile plutonium isotopes (e.g., plutonium-239), non-fissile plutonium isotopes (e.g., plutonium-240, plutonium-242), or any combination of uranium and plutonium isotopes. The actinide feedstock may be a solid in powder form having an average particle size of from about 5 μm to about 500 μm, such as from about 10 μm to about 100 μm, or from about 50 μm to about 300 μm. The amount of the actinide feedstock added to the milling/mixing unit may account for from about 5 wt % to about 95 wt % of the total amount of milled mixture formed, such as from about 20 wt % to about 80 wt %, from about 30 wt % to about 70 wt %, from about 45 wt % to about 55 wt %, or from about 30 wt % to about 45 wt % of the total amount of milled mixture formed.

In accordance with some embodiments of the disclosure, the method 1000 of forming an actinide-yttrium hydride includes an optional act 1250, as indicated by the offset text box appearing in dashed lines in FIG. 2, of introducing (e.g., adding) an additive feedstock (e.g., a solid additive feedstock) to the milling/mixing unit. The additive feedstock may be a solid in powder form and, similar to the yttrium feedstock and the actinide feedstock, the additive feedstock may have an average particle size of from about 5 μm to about 500 μm, such as from about 10 μm to about 100 μm, or from about 50 μm to about 300 μm. The amount of the additive feedstock added to the milling/mixing unit may range from 0 wt % (i.e., no additive feedstock is added to the milling/mixing unit 20) to about 10 wt % of the total amount of the milled mixture formed, such as from about 0 wt % to about 4 wt %, from about 4 wt % to about 8 wt %, or from about 8 wt % to about 10 wt % of the total amount of milled mixture formed. An additive feedstock may include a burnable absorber. In accordance with embodiments of the disclosure, the burnable absorber is one or more of boron (B), gadolinium (Gd), erbium (Er), europium (Eu), samarium (Sm), dysprosium (Dy), hafnium (Hf), cadmium (Cd), indium (In), lutetium (Lu), iridium (Ir).

Looking again to FIG. 2, the method 1000 of forming an actinide-yttrium hydride includes an act 1300 of milling and mixing the feedstocks (e.g., solid feedstocks) in the milling/mixing unit (e.g., milling/mixing unit 20) to form a milled mixture. In accordance with some embodiments, the act 1300 of milling and mixing the feedstocks is carried out in the milling/mixing unit configured to perform high-speed ball-milling. After milling and mixing, the different feedstocks (e.g., yttrium feedstock, actinide feedstock, optional additive feedstock) in the milled mixture may be reduced to an average particle size of from about 300 nm to about 50 μm, such as from about 300 nm to about 1 μm, or from about 1 μm to about 50 μm, and the different feedstocks are substantially homogeneously distributed throughout the milled mixture.

The method 1000 of forming an actinide-yttrium hydride in accordance with embodiments of the disclosure includes an act 1400 of transferring the milled mixture to a consolidation unit (e.g., a consolidation unit 30). The method also includes an act 1500 of maintaining a consolidation temperature in the consolidation unit throughout a consolidation process. The consolidation temperature may be from about 20° C. to about 1150° C., such as from about 20° C. to about 250° C., from about 250° C. to about 450° C., from about 450° C. to about 700° C., from about 700° C. to about 900° C., or from about 900° C. to about 1150° C., (e.g., about 700° C.). The method further includes an act 1600 of maintaining a consolidation pressure in the consolidation unit throughout a consolidation process. For ECAE, the consolidation pressure may depend on the angle of the elbow in the channel and for HIP, the consolidation pressure may range from about 50 MPa to about 10,000 MPa. While FIG. 2 shows acts 1500 and 1600 conducted sequentially, the acts 1500, 1600 may be conducted on the milled mixture substantially simultaneously.

With continued reference to FIG. 2, the method 1000 of forming an actinide-yttrium hydride includes an act 1700 of consolidating the milled mixture in the consolidation unit at the consolidation temperature and the consolidation pressure to form a high-density bulk solid material. In accordance with some embodiments of the disclosure, the act 1700 of consolidating the milled mixture in the consolidation unit is carried out in a consolidation unit configured to perform high-temperature equal channel angular extrusion, or high-temperature ECAE. In accordance with other embodiments, the act 1700 of consolidating the milled mixture in the consolidation unit is carried out in a consolidation unit configured to perform hot isostatic pressing.

The method 1000 of forming an actinide-yttrium hydride also includes an act 1800 of exposing the high-density bulk solid material to hydrogen in a hydriding unit (e.g., hydriding unit 60) at a hydriding temperature and a hydriding pressure to form the actinide-yttrium hydride (e.g., uranium-yttrium hydride (U—YHₓ), plutonium-yttrium hydride (Pu—YHₓ), or uranium-plutonium-yttrium hydride (U—Pu—YHₓ)). In accordance with some embodiments of the disclosure, the hydriding unit is maintained at a hydriding temperature of about 700° C. and a hydrogen gas partial pressure of about 0.122 Torr (about 16.27 pascals). Further, the hydriding process may be conducted slowly in the hydriding unit to minimize (e.g., prevent) cracking of the actinide-yttrium hydride. The hydriding process may, for example, be conducted over the course of about a week. The actinide-yttrium hydride may exhibit a nanostructure that includes nanoparticles of the actinide phase within the nanocrystalline yttrium phase. The actinide-yttrium hydride may be recovered and collected from the hydriding unit.

The An—YHₓ may, for example, be used as a nuclear fuel. The An—YHₓ may also be used in any application for which An—ZrHₓ is used. The An—YHₓ nuclear fuel may prove to be favorable to UO₂ for light water reactors (LWRs), either standard (GW-scale) size or small modular reactor (SMR) size, due to the far superior thermal conductivity of An—YHₓ. The high temperature achieved during the method 1000 softens the solid materials, enabling the solid materials to be more easily forced through the channel while recovering defects and minimizing porosity. The resulting An—YHₓ may exhibit a bulk nanostructure while including low amounts of defects, minimal porosity, and low texture.

The methods and systems according to embodiments of the disclosure offer several advantages over conventional methods and systems for forming actinide-yttrium hydride nuclear fuels. For example, the methods and systems according to embodiments of the disclosure produce the actinide-yttrium hydride with a nanostructure having equiaxed nanograins with low crystallographic texture. This nanostructure resists irradiation induced coarsening, swelling, and cracking, which in turn preserves mechanical integrity and fission product retention throughout extended burn ups of the actinide-yttrium hydride. Conventional methods and systems produce an actinide-yttrium hydride with residual porosity which leads to disintegration at reactor-relevant fuel temperatures. In addition, the actinide-yttrium hydride nuclear fuel formed in accordance with embodiments of the disclosure provides several advantages over conventional nuclear fuels. For example, An—YHₓ may exhibit greater hydrogen retention than An—ZrHₓ at higher temperatures and for longer fuel-cycle durations, and is less prone than An—ZrHₓ to hydrogen dissociation and release at higher temperatures. As a dispersion-type fuel, An—YHₓ exhibits better dimensional stability at high burnups. The An—YHₓ fuel may be a metallic uranium and/or plutonium dispersant having the maximum uranium and/or plutonium content in comparison to dispersants with uranium and/or plutonium compounds. These attributes make An—YHₓ an improved fuel for microreactors where the volume and weight of the reactor core need to be minimized. An—YHₓ also provides the neutronics necessary to perform frequent high-power reactor pulses safely while maintaining thermophysical integrity and hydrogen stability at high temperatures. Because actinides and yttrium are immiscible as solids, the two components may not deleteriously interact with each other during use, minimizing the formation of low-melting or brittle intermetallic phases; because actinides and yttrium are immiscible as liquids, fuel reprocessing may involve a simple melting operation to separate the actinides and yttrium. Similar to An—YHₓ, yttrium-based composites with up to 65 wt % uranium are compatible with molten sodium coolant up to at least 650° C. The An—YHₓ matrix may be more stable than ZrHₓ at high burnups because yttrium is less reactive with fission products than zirconium.

Without being tied to any theory, it is believed that putting an actinide (e.g., uranium and/or plutonium) and yttrium-hydride together causes a so-called “negative feedback coefficient,” which means that when the reactor's power output (e.g., fission rate) increases, hydrogen immediately loses some of its capability of slowing down the neutrons and, as a result, reactivity decreases. Therefore, the actinide-yttrium hydride nuclear fuel is formulated to shut itself down instantly when power increases, which improves safety in reactor operations.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalent. For example, elements and features disclosed in relation to one embodiment may be combined with elements and features disclosed in relation to other embodiments of the disclosure.

What is claimed is:

1. A method of forming an actinide-yttrium hydride, comprising:
introducing an yttrium feedstock to a milling/mixing unit;
introducing an actinide feedstock to the milling/mixing unit;
milling and mixing the yttrium feedstock and the actinide feedstock to form a milled mixture;
consolidating the milled mixture in a consolidation unit at a consolidation temperature to form a high-density bulk solid material; and
exposing the high-density bulk solid material to hydrogen at a hydriding temperature and a hydriding pressure to form the actinide-yttrium hydride.

2. The method of claim 1, wherein introducing an actinide feedstock to the milling/mixing unit comprises introducing one or more of uranium and plutonium to the milling/mixing unit.

3. The method of claim 1, wherein milling and mixing the yttrium feedstock and the actinide feedstock to form the milled mixture comprises milling and mixing the yttrium feedstock and the actinide feedstock via high-energy ball milling, jet milling, or cryomilling to form the milled mixture comprising microparticles of yttrium and microparticles of one or more of uranium and plutonium.

4. The method of claim 1, wherein consolidating the milled mixture in a consolidation unit comprises consolidating the milled mixture in a consolidation unit configured to perform high-temperature equal channel angular extrusion or hot isostatic pressing on the milled mixture.

5. The method of claim 1, further comprising performing one or more of standard pressureless sintering and electric field-assisted sintering on the milled mixture before consolidating the milled mixture in a consolidation unit.

6. The method of claim 1, wherein consolidating the milled mixture in a consolidation unit comprises maintaining the consolidation temperature in the consolidation unit at from about 20° C. to about 1150° C.

7. The method of claim 1, wherein consolidating the milled mixture in a consolidation unit comprises maintaining a consolidation pressure in the consolidation unit at from about 50 megapascals to about 10,000 megapascals.

8. The method of claim 1, further comprising introducing an additive feedstock comprising a burnable absorber to the milling/mixing unit.

9. The method of claim 8, wherein introducing the additive feedstock to the milling/mixing unit comprises introducing the additive feedstock to have a concentration of less than about 5% by weight of the milled mixture.

10. The method of claim 9, wherein introducing the additive feedstock to the milling/mixing unit comprises introducing the additive feedstock comprising one or more of boron, gadolinium, erbium, europium, samarium, dysprosium, hafnium, cadmium, indium, lutetium, and iridium.

11. The method of claim 1, wherein exposing the high-density bulk solid material to hydrogen at the hydriding temperature to form the actinide-yttrium hydride comprises exposing the high-density bulk solid material to hydrogen at a temperature of from about 500° C. to about 900° C.

12. A composition comprising yttrium hydride and one or more actinides, the composition exhibiting a bulk nanostructure.

13. The composition of claim 12, wherein the one or more actinides comprise one or more of uranium and plutonium.

14. The composition of claim 13, wherein the bulk nanostructure comprises a matrix of the yttrium-hydride with inclusions comprising the one or more of uranium and plutonium.

15. The composition of claim 14, wherein the inclusions are located at grain boundaries of the yttrium-hydride matrix.

16. The composition of claim 14, wherein:
a grain size of the yttrium hydride is from about 70 nm to about 150 nm; and
a grain size of the one or more of uranium and plutonium is from about 10 nm to about 60 nm.

17. The composition of claim 12, wherein the yttrium-hydride exhibits a delta phase crystal structure.

18. A system for forming an actinide-yttrium hydride material, comprising:
a milling/mixing unit configured to reduce an average particle size of an yttrium feedstock and an actinide feedstock to form a milled mixture;
a consolidation unit coupled to the milling/mixing unit and configured to consolidate the milled mixture of the yttrium feedstock and the actinide feedstock into a high-density solid material; and
a hydriding unit coupled to the consolidation unit and configured to hydride the high-density solid material.

19. The system of claim 18, wherein the milling/mixing unit is configured to reduce the average particle size of the yttrium feedstock and the actinide feedstock to from about 300 nm to about 50 μm.

20. The system of claim 19, wherein the consolidation unit is configured to consolidate the milled mixture under an inert atmosphere.
